(19) United States
(12) Patent Application Publication
(10) Pub. No.: US 2021/0377646 A1
(43) Pub. Date: Dec. 2, 2021

(54) SPLIT-TYPE WIRELESS EARPHONES

(71) Applicant: Shenzhen Weiking Technology Co., Ltd., Shenzhen (CN)

(72) Inventor: Fuguang Luo, Shenzhen (CN)

(21) Appl. No.: 16/911,593

(22) Filed: Jun. 25, 2020

(30) Foreign Application Priority Data
Jun. 2, 2020 (CN) 202020982364.5

(51) Int. Cl. H04R 1/10

(52) U.S. Cl. CPC H04R 1/1025; H04R 2420/07; H04R 1/1016

(57) ABSTRACT

Split-type wireless earphones include a charging case bottom shell hingedly mounted on one side of a charging case face shell, two charging case middle frames disposed symmetrically on the charging case bottom case, a left earphone and a right earphone placed in the two charging case middle frames respectively, both including a bent tube, a battery fixedly mounted at one end of the bent tube through a battery compartment, an earphone rear housing provided on one side of the bent tube far away from the battery compartment and an earphone front chamber fixedly mounted on one side of the earphone rear housing far away from the bent tube, a main board fixedly mounted on the battery, an antenna board mounted on one side of the main board far away from the battery, and a speaker fixedly mounted in the earphone rear housing through a speaker support.

### CROSS REFERENCE TO RELATED APPLICATIONS

The present application claims the benefit of Chinese Patent Application No. 202020982364.5 filed on Jun. 2, 2020, the contents of which are incorporated herein by reference in their entirety.

### TECHNICAL FIELD

The present disclosure relates to the technical field of earphones, in particular to split-type wireless earphones.

### BACKGROUND TECHNOLOGY

Earphones are a pair of conversion units. They receive electric signals transmitted from a media player or a receiver, and use speakers close to the ears to convert the signals into audible sound waves. The earphones are generally detachable from the media player and are connectable to the media player using a plug. The advantage is that a user can listen to the sound alone without affecting other people. The earphones can also block the sound of the surrounding environment. This is very helpful for people who use them in noisy environments such as recording studio, bar, travel, sport, etc. Earphones were originally used for telephone and wireless communication. However, with the prevalence of portable electronic devices, earphones are mostly used for mobile phone, Walkman, radio, portable video game and digital audio player, etc.

Existing products come as a whole or with a wire, and the shape is relatively simple. The existing products are rather troublesome to produce, assemble and repair. If they need to be repaired, the casing needs to be damaged and discarded. The existing products have a compact structure and have a great restriction in sound quality and battery capacity. Since all components are installed within a single cavity, the size of the existing products is rather large, and long term wearing will be hard for the ears to hold and tolerate, and will affect the wearing experience. Since all components of the existing products are installed within a single cavity, any accident caused by the batteries can easily cause injury to the ear canals.

### SUMMARY

An object of the present application is that in order to solve the problem mentioned above, split-type wireless earphones are provided.

The technical solution adopted by the present disclosure is to provide split-type wireless earphones including a charging case face shell, a charging case bottom shell, a left earphone and a right earphone, the charging case bottom shell being hingedly mounted on one side of the charging case face shell, two charging case middle frames disposed symmetrically on the charging case bottom case, the left earphone and the right earphone being placed in the two charging case middle frames respectively, the left earphone and the right earphone both including a bent tube, a battery, an earphone rear housing and an earphone front chamber, the battery being fixedly mounted at one end of the bent tube through a battery compartment, a main board fixedly mounted on the battery, an antenna board mounted on one side of the main board far away from the battery, the earphone rear housing provided on one side of the bent tube far away from the battery compartment, a speaker fixedly mounted in the earphone rear housing through a speaker support, the earphone front chamber fixedly mounted on one side of the earphone rear housing far away from the bent tube, and an ear cap fixedly mounted on one side of the earphone front chamber far away from the earphone rear housing.

In a preferred embodiment, the bent tube adopts a setting of a soft plastic bent tube, and a bending angle of the soft plastic bent tube is 58°.

In a preferred embodiment, the battery compartment is formed of a battery compartment front housing and a battery compartment rear housing, the battery compartment front housing is snap-fittingly engaged with the battery compartment rear housing, wherein the battery, the main board and the antenna board are all mounted between the battery compartment front housing and the battery compartment rear housing, and a magnet is fixedly mounted in the battery compartment front housing.

In a preferred embodiment, one end of the bent tube is inserted into the earphone rear housing, and another end of the bent tube far away from the earphone rear housing is inserted into the battery compartment rear housing.

In a preferred embodiment, the earphone front chamber is snap-fittingly engaged with the earphone rear housing to form an earphone cavity.

In a preferred embodiment, the speaker is electrically connected to the main board through an electric wire.

In summary, due to the adoption of the above technical solution, the beneficial effects of the present disclosure are:

In the present disclosure, the earphone cavity and the battery compartment are connected by a soft plastic bent tube to form a complete wireless earphone. The specific angle of the soft plastic bent tube is 58° so that the battery compartment can be wound behind the earlobe. Combining ergonomics and principle of leverage, the earphones are comfortable to wear, and the whole set of earphones can be securely worn for a long time without falling out. It takes into account of comfort, secureness and convenience. At the same time, the battery compartment front housing is snap-fittingly engaged with the battery compartment rear housing, and the earphone front chamber is snap-fittingly engaged with the earphone rear housing. Furthermore, one end of the bent tube is inserted into the earphone rear housing, and the other end of the bent tube is inserted into the battery compartment rear housing. Due to this split earphone design, the problems of complicated assembly, repairing and discarding can be solved, and the costs can be reduced. Since the user's ear canals are not close to the batteries, injury can be reduced or avoided in case explosion and liquid leakage caused by the batteries occur. This improves safety and becomes more practical.

### BRIEF DESCRIPTION OF THE DRAWINGS

FIG. 1 is a schematic diagram of the overall structure of the present disclosure;

FIG. 2 is a schematic diagram of the structure of a charging case of the present disclosure;

FIG. 3 is a schematic diagram of the structure of a left earphone of the present disclosure;

FIG. 4 is a schematic diagram of the overall structure of the left earphone of the present disclosure;

FIG. 5 is a schematic diagram of the structure of a bottom shell of the charging case of the present disclosure;

FIG. 6 is a right side view of the structure of the present disclosure;

FIG. 7 is a left side view of the structure of the present disclosure;

FIG. 8 is a rear view of the structure of the present disclosure.

Symbols in the figures: 1, charging case face shell; 2, charging case bottom shell; 3, charging case middle frame; 4, left earphone; 5, right earphone; 6, bent tube; 7, battery; 8, main board; 9, battery compartment front housing; 10. antenna board; 11, battery compartment rear housing; 12, magnet; 13, earphone rear housing; 14, speaker; 15, support; 16, earphone front chamber; 17, ear cap.

### DETAILED DESCRIPTION OF EMBODIMENTS

In order to make the purposes, technical solutions and advantages of the embodiments of the present disclosure clearer, the technical solutions of the embodiments of the present disclosure will be described clearly and completely in conjunction with the embodiments of the present disclosure. Obviously, the described embodiments are a part of the embodiments of the present disclosure, but not all of the embodiments. Based on the embodiments in the present application, all other embodiments obtained by a person of ordinary skill in the art without contributing creative efforts fall within the scope of protection of the present disclosure.

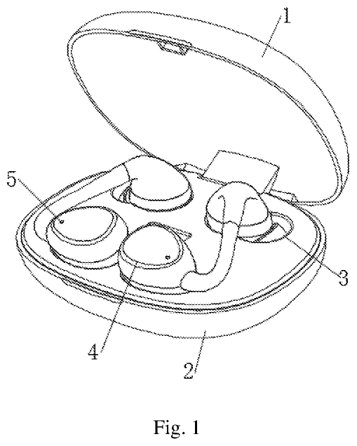

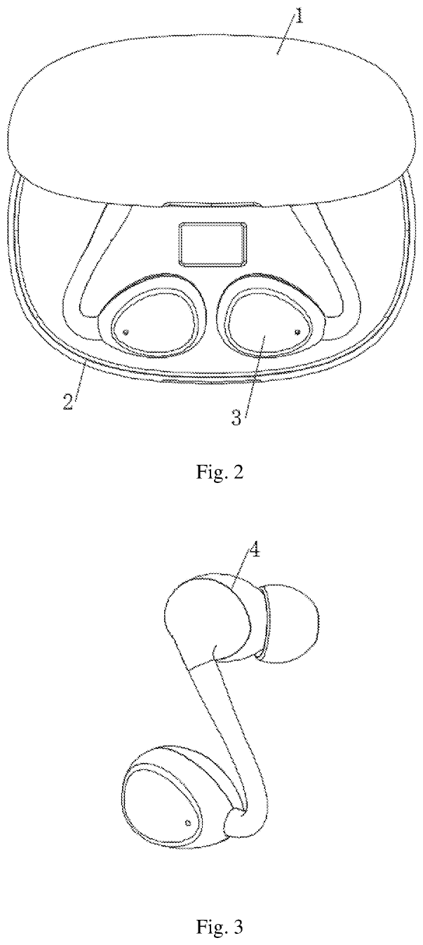

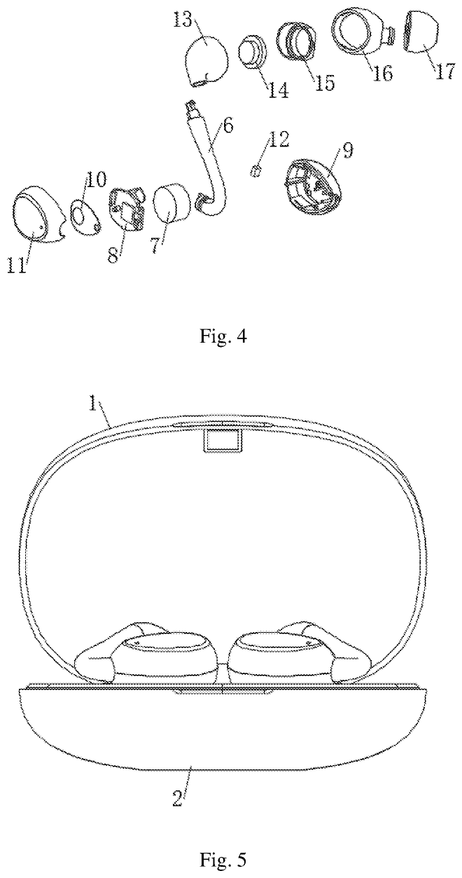

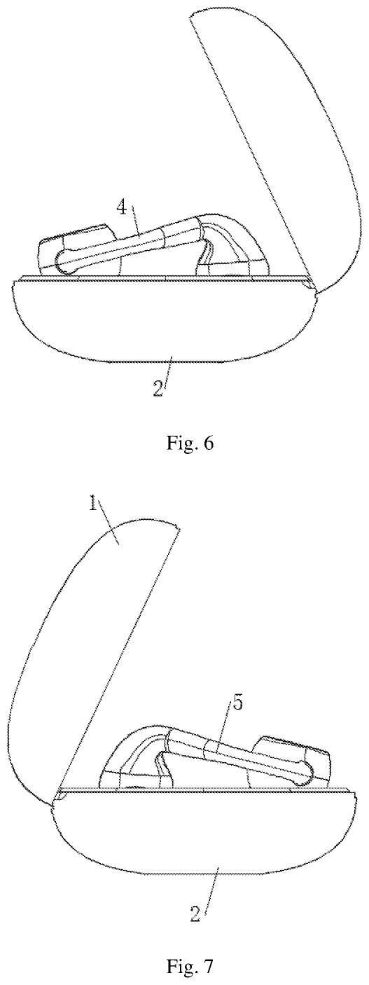

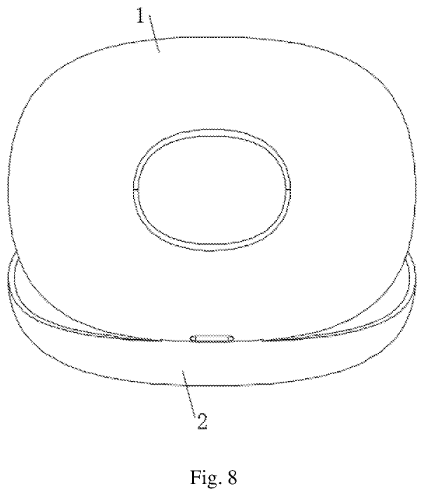

Referring to FIGS. 1-8, the split-type wireless earphones include a charging case face shell 1, a charging case bottom shell 2, a left earphone 4 and a right earphone 5. The charging case bottom shell 2 may be hingedly mounted on one side of the charging case face shell 1. Two charging case middle frames 3 may be disposed symmetrically on the charging case bottom case 2, and the left earphone 4 and the right earphone 5 can be placed in the two charging case middle frames 3 respectively. Both of the left earphone 4 and the right earphone 5 may include a bent tube 6, a battery 7, an earphone rear housing 13 and an earphone front chamber 16. The battery 7 may be fixedly mounted at one end of the bent tube 6 through a battery compartment. A main board 8 may be fixedly mounted on the battery 7. An antenna board 10 may be mounted on one side of the main board 8 far away from the battery 7. The earphone rear housing 13 may be provided on one side of the bent tube 6 far away from the battery compartment. A speaker 14 may be fixedly mounted in the earphone rear housing 13 through a speaker support 15. The earphone front chamber 16 may be fixedly mounted on one side of the earphone rear housing 13 far away from the bent tube 6. An ear cap 17 may be fixedly mounted on one side of the earphone front chamber 16 far away from the earphone rear housing 13.

Furthermore, the bent tube 6 may adopt a setting of a soft plastic bent tube, and the bending angle of the soft plastic bent tube may be 58°. The specific angle of 58° renders the battery compartment to be wound behind the earlobe. Combining ergonomics and principle of leverage, the earphones are comfortable to wear, and the whole set of earphones can be securely worn for a long time without falling out. It takes into account of comfort, secureness and convenience.

Furthermore, the battery compartment may be formed of a battery compartment front housing 9 and a battery compartment rear housing 11. The battery compartment front housing 9 can be snap-fittingly engaged with the battery compartment rear housing 11.

The battery 7, the main board 8 and the antenna board 10 may be all mounted between the battery compartment front housing 9 and the battery compartment rear housing 11. A magnet 12 may be fixedly mounted in the battery compartment front housing 9. This renders a split design of the battery compartment, formed by the battery compartment front housing 9 and the battery compartment rear housing 11, which can be disassembled for maintenance.

Furthermore, one end of the bent tube 6 may be inserted into the earphone rear housing 13, and another end of the bent tube 6 far away from the earphone rear housing 13 may be inserted into the battery compartment rear housing 11. This renders a split design of the bent tube 6 with the earphone rear housing 13 and the battery compartment rear housing 11 which can be disassembled for maintenance.

Furthermore, the earphone front chamber 16 can be snap-fittingly engaged with the earphone rear housing 13 to form an earphone cavity. This renders a split design of the earphone cavity, formed by the earphone front chamber 16 and the earphone rear housing 13, which can be disassembled for maintenance.

Furthermore, the speaker 14 can be electrically connected to the main board 8 through an electric wire.

When the earphone is in use, the ear cap 17 can be installed on the earphone front chamber 16. The speaker 14 may be fixedly mounted in the earphone rear housing 13 through the speaker support 15. The earphone front chamber 16 and the earphone rear housing 13 together form the earphone cavity. The battery compartment front housing 9 and the battery compartment rear housing 11 together form the battery compartment. The battery 7, the main board 8, the antenna board 10 and the magnet 12 may be installed in the battery compartment. The battery 7 may be mounted on the main board 8. The speaker 14 can be electrically connected to the main board 8 through an electric wire. One end of the bent tube 6 may be inserted into the earphone rear housing 13, and another end of the bent tube 6 may be inserted into the battery compartment rear housing 11. The earphone cavity and the battery compartment are connected by the soft plastic bent tube to form a complete wireless earphone. The specific angle of the soft plastic bent tube is 58° so that the battery compartment can be wound behind an earlobe. Combining ergonomics and the principle of leverage, the earphones are comfortable to wear, and the whole set of earphones can be securely worn for a long time without falling out. It takes into account of comfort, secureness and convenience. At the same time, the battery compartment front housing 9 is snap-fittingly engaged with the battery compartment rear housing 11, and the earphone front chamber 16 is snap-fittingly engaged with the earphone rear housing 13. Furthermore, one end of the bent tube 6 is inserted into the earphone rear housing 13, and the other end of the bent tube 6 is inserted into the battery compartment rear housing 11. Due to this split earphone design, the problems of complicated assembly, repairing and discarding of components can be solved, and the costs can be reduced. Since the user's ear canal is not close to the battery 7, injury can be reduced or avoided in case explosion and liquid leakage caused by the battery 7 occur. This improves safety and becomes more practical.

It should be noted that in this specification, the relational terms such as “first” and “second” are only used to distinguish one entity or operation from another entity or operation, and do not necessarily require or imply that there is any such actual relationship or order among these entities or operations. Moreover, the terms “comprise”, “include” or any other variants thereof are intended to cover non-exclusive inclusion, so that a process, method, article, or device having a series of elements includes not only those elements, but also those not explicitly listed, or other elements that are inherent to that process, method, article, or device. Without further restrictions, an element defined by the expression “comprising one . . . ” does not exclude that there are other identical elements in the process, method, article or device that includes the element.

The above embodiments are merely provided to illustrate, rather than limit, the technical solution of the present disclosure. Although the embodiments of the present disclosure have been described in detail, those of ordinary skill in the art should understand that the technical solution of each of the above described embodiments can be modified, or some of the technical features can be equivalently replaced, and these modifications or replacements do not deviate the essence of the corresponding technical solutions from the spirit and scope of the technical solutions of the embodiments of the present disclosure.

What is claimed is:

1. Split-type wireless earphones having a charging case face shell (1), a charging case bottom shell (2), a left earphone (4) and a right earphone (5), the split-type wireless earphones comprising: the charging case bottom shell (2) being hingedly mounted on one side of the charging case face shell (1), two charging case middle frames (3) disposed symmetrically on the charging case bottom case (2), the left earphone (4) and the right earphone (5) being placed in the two charging case middle frames (3) respectively, the left earphone (4) and the right earphone (5) both comprising a bent tube (6), a battery (7), an earphone rear housing (13) and an earphone front chamber (16), the battery (7) being fixedly mounted at one end of the bent tube (6) through a battery compartment, a main board (8) fixedly mounted on the battery (7), an antenna board (10) mounted on one side of the main board (8) far away from the battery (7), the earphone rear housing (13) provided on one side of the bent tube (6) far away from the battery compartment, a speaker (14) fixedly mounted in the earphone rear housing (13) through a speaker support (15), the earphone front chamber (16) fixedly mounted on one side of the earphone rear housing (13) far away from the bent tube (6), and an ear cap (17) fixedly mounted on one side of the earphone front chamber (16) far away from the earphone rear housing (13).

2. The split-type wireless earphones according to claim 1, wherein the bent tube (6) adopts a setting of a soft plastic bent tube, and a bending angle of the soft plastic bent tube is 58°.

3. The split-type wireless earphones according to claim 1, wherein the battery compartment is formed of a battery compartment front housing (9) and a battery compartment rear housing (11), the battery compartment front housing (9) is snap-fittingly engaged with the battery compartment rear housing (11), wherein the battery (7), the main board (8) and the antenna board (10) are all mounted between the battery compartment front housing (9) and the battery compartment rear housing (11), and a magnet (12) is fixedly mounted in the battery compartment front housing (9).

4. The split-type wireless earphones according to claim 2, wherein one end of the bent tube (6) is inserted into the earphone rear housing (13), and another end of the bent tube (6) far away from the earphone rear housing (13) is inserted into the battery compartment rear housing (11).

5. The split-type wireless earphones according to claim 1, wherein the earphone front chamber (16) is snap-fittingly engaged with the earphone rear housing (13) to form an earphone cavity.

6. The split-type wireless earphones according to claim 1, wherein the speaker (14) is electrically connected to the main board (8) through an electric wire.
